(19) United States
(12) Patent Application Publication
(10) Pub. No.: US 2008/0284154 A1
(43) Pub. Date: Nov. 20, 2008

(54) System and Method of Baby Organization

(76) Inventor: Kerrie P. Waldis, Lumberton, NJ (US)

Correspondence Address: GIBBONS P.C., ONE GATEWAY CENTER, NEWARK, NJ, 07102, US

(21) Appl. No.: 12/100,759

(22) Filed: Apr. 10, 2008

Related U.S. Application Data
(60) Provisional application No. 60/922,774, filed on Apr. 10, 2007.

(51) Int. Cl. B42D 1/08; G09B 19/00

(52) U.S. Cl. 281/22; 283/52.1

(57) ABSTRACT

A log directed to the organization of a baby's schedule is disclosed. The log includes a writeable platform for entering at least one information item, an output entry portion of the writeable platform, an input entry portion of the writeable platform and at least one guideline related to at least one of the input entry, output entry and the at least one information item. Further, the output entry is related to the at least one information item and designated to correspond to various output characteristics, the input entry is related to the at least one information item and designated to correspond to various input characteristics. Further, the log of the present invention is designed to enable feedback related to the at least one information item and the at least one guideline.

### PRIORITY INFORMATION

This application claims the benefit of U.S. Provisional Application Ser. No. 60/922,774 entitled “System and Method of Baby Organization”, filed Apr. 10, 2007, the disclosure of which is incorporated herein as if set forth in its entirety.

### FIELD OF THE INVENTION

This application is directed to an organizational tool and particularly to a tool for organization related to a baby, and more particularly, to a organizational tool related to the feeding, eating, and bodily functions of a baby.

### BACKGROUND OF THE INVENTION

From experience, it is extremely difficult to keep track of a baby's feeding schedule by memory alone. Because sleep deprivation is a common occurrence with new parents, it often becomes necessary to record feeding data in a notebook in order to stay organized. Writing a down the number of bottles that were fed to the baby, as well as the times the bottles were given, will help control what a child is eating, and aid in determining whether increased formula is necessary. By recording not only the baby's feeding schedule, but also sleeping patterns and allergic reactions to certain formulas, better communication with the doctor during monthly visits may also be achieved.

While there are notebooks, journals, and software programs available to assist people with information management, there is currently no product that enables a new mother to keep track of all of the necessary information in a single convenient location. Thus, a need exists to provide an organizational tool to new parents for enabling the organization of information relating to feedings, bottles, wet and dirty diapers and other baby bodily functions to thereby enable parents to function more efficiently.

### SUMMARY OF THE INVENTION

A log directed to the organization of a baby's schedule is described. The log includes a writeable platform for entering at least one information item, an output entry portion of the writeable platform, where the output entry is related to the at least one information item and designated to correspond to various output characteristics. Also included is an input entry portion of the writeable platform, the input entry being related to the at least one information item and designated to correspond to at least one of various input characteristics. Further included is at least one guideline related to at least one of the input entry, the output entry and the at least one information item, where the log enables feedback derived from the at least one information item and the at least one guideline.

Further, the log may be in hard copy form or soft copy form, such as resident on a PDA, for example.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a depiction of the log according to an aspect of the present invention; and,

FIG. 2 is a depiction of a columnar setup of a page of the log of FIG. 1 according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in a baby organizational tool. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, a “tool” or a “log” may be in paper or electronic form, such as software. A tool for recording information relating to an infant, such as how much the baby eats and wets, is disclosed. The recording may occur in such a fashion as to establish clear values for the baby's intake and output in a given day. Such valuation may provide the user necessary information for monitoring the baby's well being and also for providing information to a doctor or other trained personnel in order to have the proper managed care. The recording of the intake and output of the baby may be such that daily tabulations occur and are compared on a daily or semi weekly basis, for example, either by comparing relative to another week or day, or comparing on average over a time period, such as a week, to a known expected intake or output. Further, comparison may be performed against external data, which external data may be downloaded, incorporated, or otherwise accessed in real time or in accordance with a predetermined periodicity. For example, information as to average heights, weights, or food consumption may be taken from one or more baby related websites monthly, for comparison to the baby of interest's status. Tabulations of such external comparisons may also de displayed in the present invention. Similarly, the intake and output may be compared daily, or on average over a time frame, against each other to ensure that the export and import for the baby are in balance.

A method to evaluate whether the baby is eliminating properly is also provided. Such a method may include the use of input parameters such as those included within the present organizer. Additionally and alternatively, external information may be incorporated to provide comparative feedback with respect to the baby's eliminating in a manner similar to that discussed hereinabove with respect to height and weight. Knowing how much intake a baby has had may be helpful in determining the amount of output to be expected and then having this expected output compared to the actual output. Further, comparison of an expected output, based on parameters such as age, weight and height, for example, to the actual output may also be performed. Such comparisons may provide statistical information about the functions that a baby is undergoing and provide the parents and care givers with necessary information in helping the baby grow. Similarly, comparisons may be performed at various stages of the baby's development, such as to insure proper growth and health of the baby over time.

Further, according to an aspect of the present invention, an indicator of dates and times to increase formula/baby food may be provided. Such an indicator may be based on such parameters as output levels, comparison of input and output, or based on factors such as the baby's increased age or weight, by way of non limiting examples only. The indicator may be tripped electronically, as would be known to those possessing an ordinary skill in the pertinent arts, and may also be related to an on going comparison of the baby's needs. The indicator may also take the form of a running total that upon eclipsing a given value indicates an increase in food may be warranted.

The present invention may also include a record of the first time a baby sleeps through the night. This may also provide an indication of the foods and other functions that the baby achieved leading up to the monumental event and provide an opportunity for replication of the day's routine, for example.

According to an aspect of the present invention, the organizer may include removable, separately printable, or otherwise separable pages. This feature may allow for easier copying in a copy machine, or may allow a page to be removed or printed from the organizer and delivered to a pediatrician or other healthcare professional. The separable pages may also be handed out to infant caregivers, such as a nanny or babysitter, for the caregiver to separably record any feedings, wettings, or other important information relating to the infant while the parent is away. This may allow the parent to retain the organizer for safe keeping, while still providing a manner for alternate caregivers to create data entries for the infant.

In another aspect of the present invention, a physical organizer may include pockets for holding items, such as additional and separable pages, pamphlets, schedules, lists, pens, pencils, or any other item that may be beneficial for use with the organizer. These pockets may be located in a variety of places, such as on the exterior or interior surface of the cover of the organizer, on individual pages used for data entry, or they may be used as an entirely separate “pocket page”, which may be inserted between any other pages of the organizer. For example, on the day that the infant loses his or her first tooth, the actual tooth may be placed safely in a small sealable bag, and further placed in a pocket of the organizer corresponding to the date and time the tooth was lost. In yet another example, a few strands of hair from the infant's first haircut may also be preserved and placed in a pocket of the organizer, and a date and time corresponding to the haircutting event.

According to another aspect of the present invention, the organizer may include predictive data already entered into the organizer, such as data relating to average time periods for when an infant first rolls over, walks, says a first word, gets a first tooth, or any other milestone generally used to mark the development of an infant during the infant's first years of life. Predictive data may assist a parent or caregiver in anticipating when a developmental event might occur, or help aid a parent in the decision to report to a pediatrician the fact that a certain event may not have occurred when it should have. For example, a predictive data item may be placed at approximately three months from birth, to correspond to the infant first rolling over from lying on his or her belly to lying on their back. As the infant approaches three months of age, the parent may watch more closely for the event to occur. Alternatively, in the event that the infant has not rolled over and it has been three months beyond the predictive data point, the parent or caregiver may wish to consult a pediatrician with their concern of the event not taking place.

Predictive data may take the form of average times for the developmental milestone to take place, for example, based on averages provided by a reputable source such as the American Medical Association, American Academy of Pediatrics, the Mayo Clinic, or even a specific physician, such as Dr. William Sears, MD, and which may be provided in paper or electronically accessed as discussed above. Alternatively, because every person or family develops at different rates, predictive data may be customized to a particular family. For example, a parent or caregiver may import the timing of developmental milestones of their previous children into the organizer.

According to another aspect of the present invention, a parent or caregiver having multiple babies may utilize and swap predictive data between multiple organizers. Further, the organizer may provide algorithms for combining and averaging multiple sources of predictive data. This feature may assist in providing not only individual predictive data points within the organizer, but may also provide predictive “windows” for events to occur.

In one embodiment of the present invention, the aforementioned indicators may be situated to alert a parent or caregiver that a predictive data point is approaching, or that a certain length of time has lapsed without the event occurring. For example, an indicator may be placed a week after a scheduled vaccination should have occurred, or if a predefined number of daily bottle feedings was not reached. Indicators may be used as any sort of reminder, warning or alert, as desired by the parent or caregiver.

According to another aspect of the present invention, the organizer may include designated electronic or physical regions for photographs, hand drawn pictures, or any other sort of illustrations as understood by those skilled in the art. Such regions may be predefined, such as corresponding to the first day of every month, for example. Such regions provide a form of visual data to further document the development and schedule of the infant. Such designated physical regions may also contain a releasable adhesive, such as a pressure sensitive adhesive, for easy attachment of a photograph. A release liner may also act as a protective cover of the adhesive, so that the adhesive will not cause unnecessary stickiness or tackiness between pages of the organizer if no photograph has yet been added. Of course, while such regions for adding photographs may be predefined, photographs or other artwork may be added to virtually any portion of the organizer, provided such placement does not disrupt the entry of data as described herein.

In yet another embodiment of the present invention, pages and/or the covers of the physical organizer may include a laminate, or other see through coating, to prevent damage from food, spills, or other environmental conditions. The laminate may also be separable from the protected surface on one or two edges, to allow a user to slip a photograph, paper, pamphlet, or other item between the laminate and page and/or cover, as may be typically found in a photo album.

As discussed herein throughout, the organizer may incorporate an electronic or computerized platform and/or format, having application software, which may be managed by the organizer itself or remotely by a central server. The software may include a software framework that optimizes ease of use of at least one existing software platform, and that may also extend the capabilities of at least one existing software platform. The application architecture may approximate the actual way users organize and manage data, and thus may organize use activities in a natural, coherent manner while delivering use activities through a simple, consistent, and intuitive a interface within each application and across applications. The architecture may also be reusable, providing plug-in capability to any number of applications, without extensive re-programming, which may enable parties outside of the system to create components that plug into the architecture. Thus, software or portals in the architecture may be extensible and new software or portals may be created for the architecture by any party.

The software may provide, for example, applications accessible to one or more users to perform one or more functions with a single organizer, or with multiple organizers. Such applications may be available at the same location as the user, or at a location remote from the user. Each application may provide a graphical user interface (GUI) for ease of interaction by the user with information resident in the organizer. A GUI may be specific to a user, set of users, or type of user, or may be the same for all users or a selected subset of users. The software may also provide a master GUI set that allows a user to select or interact with GUIs of one or more other applications, or that allows a user to simultaneously access a variety of information otherwise available through any portion of the system.

The software may be a portal that provides, via the GUI, remote access to and from the present invention. The software may include, for example, a network browser. The software may include the ability, either automatically based upon a user request in another application, or by a user request, to “hook”, search, or otherwise retrieve particular data from one or more remote points, such as on the internet, as discussed hereinabove. The software may vary by user type, or may be available to only a certain user types, depending on the needs of the organizer. This would allow a user, such as a parent, to link to and either upload or download data or other information relating to the infant. For example, the parent could electronically forward information to a pediatrician, or the parent could research a topic related to a developmental milestone. Users may have some portions, or all of the software, resident on the organizer, or may simply have linking mechanisms, as understood by those skilled in the art, to link the organizer to the software running on a central server via a wide area network. Software may also be provided separately and/or run separately on any organizer as described herein, providing all functionality applicable to the organizer as may be appropriate until actual connection to the wide area network (and consequently the central server) is achieved.

If a software platform is used, presentation of data through the software may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard readable formats, such as XML. Further, the software may allow other information related to their stored data that may be of interest to users, and may graphically display any portion of such information either as a separate window, or by any other mechanism understood by those skilled in the art. The software may also support any sort of interactive purchasing platform, where a user may receive advertisements and purchase items from the organizer or from any third party connected to the organizer via wide area network.

Any visual interface may be rendered by any computer code and/or programs necessary and as may be understood by those of ordinary skill in art. The visual interface may have many functions, such as present information in many forms to users, act as a conduit for users and administrators to enter information into the organizer, display user choices for selection, graphs, photographs, pictures, drawings, charts, and/or animated content, for example. In one embodiment, the visual interface may be a secured interface, such that users must log on to such an interface through a secure portal. This may require users to have an account, which may include a log on identity and password, for example, as may be understood by those of ordinary skill in the art. If the user is not an allowed user or registered user and/or not an administrator, the user may be prevented from accessing any further information. If the user is an allowed user and/or system administrator, then the user/administrator may access further information. Such security features of the visual interface may exist at any level of security, ranging from, for example, very restrictive of entry to the organizer to no restriction of entry to the organizer, as a user may choose or the administrator may desire and may be changed over time as the administrator and/or user sees the need.

A barometer to measure any problems with formula and/or food may also be included. By way of non limiting example only, the present invention may include a barometer gauged to the baby's feeding schedule wherein as the baby has reactions such as hives, puffy skin, welts, splotches, fever, redness, or swelling, the reaction may be traced back to something in the baby intake based on the timing of the reaction and the intake consumed. For example, by analyzing the time period known to occur for various symptoms to present, using the present invention, it may be possible to tie the symptoms back to a time period related to the baby's intake such as something the baby ate for lunch and thereby determine what intake caused the reaction in the baby, along with proper medical consultation.

While the present invention is designed in part to provide a compiling mechanism for the necessary and useful information during the first year of life, this time period may be extended as would be evident to those possessing and ordinary skill in the pertinent arts. In order for the present invention to function as designed it may necessarily require faithful entry of information to predict, catalog and record and therefore operate efficiently.

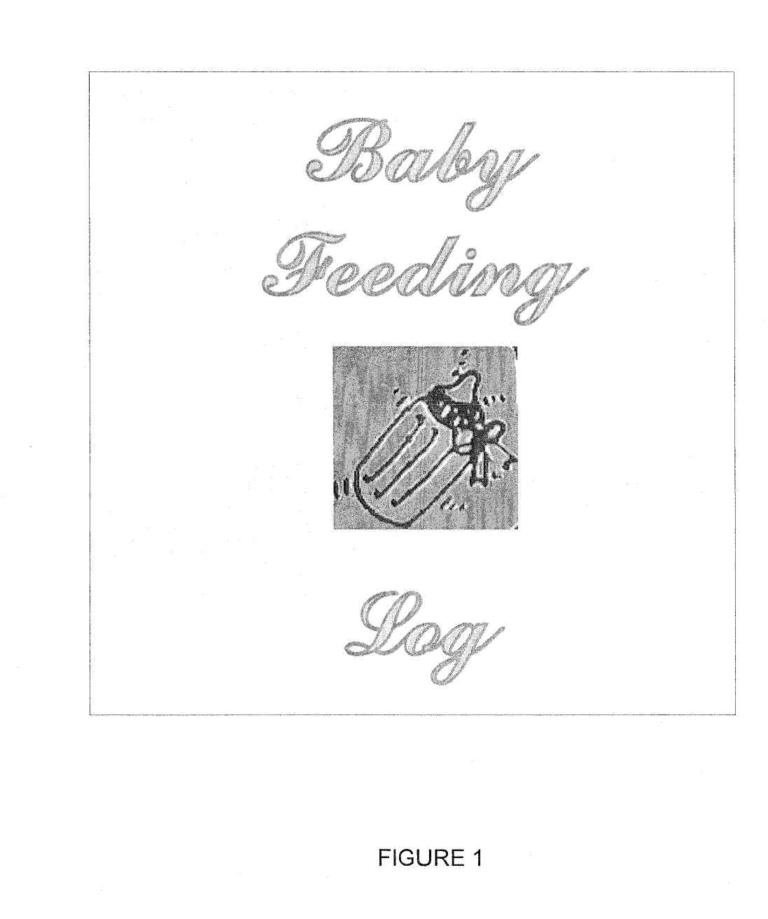

Referring now to FIG. 1, there is shown a depiction of the physical form of the present invention. As may be seen in FIG. 1, and according to an aspect of the present invention, the present design may include an 8×11 inch book. The book may be designed with 365 pages, using one page per day, for example. Additional pages may be included to provide the user with reference and the ability to remove pages at the beginning in order to align the log with the day of the week the baby was born. For example, an additional week of pages (seven) may be included and the instruction given to the user to remove the pages from the log that were before the baby was born. Further, in the event a baby is born on Wednesday, the log could be modified to begin Wednesday by removing Sunday trough Tuesday, by way of non limiting example only.

The design of the book having 365 pages would create a unique relationship between a given page and a day in the baby's life. The 365 pages would bring the baby through and into when the baby starts eating table food. The pages may be formed of paper or other types of writeable devices that allow easy note taking and writing, and render the notes and writing in a semi permanent form. The organizer may also take an electronic form, and further, the present organizer may be set on a PDA, or other type stationary or portable electronic device.

The present invention may be formed, or covered, from any material. For example, the present invention may be designed to include cloth gingham in a blue or pink fabric, or more practically designed from a plastic material that may possess a wipeable/cleanable function, wherein the material may be blue or pink. As would be evident to those possessing an ordinary skill in the pertinent arts, other colors and fabrics may be used to enhance both the functionality and aesthetic qualities of the log.

In a further example, lettering may be included on the cover identifying the product, or the product may be embroidered with the name of the baby or the last name of the family, by way of non limiting example only. Lettering may take the form of embroidery into fabric or glued metal block pressed down into fabric, by way of non limiting example only.

Various designs may also be included in the design of the cover, such as by including a metal engraved baby bottle pushed into the fabric cover, for example.

Additionally, there may also be included dividers separating the various functions of a baby as opposed to the aforementioned and discussed all on one page technique.

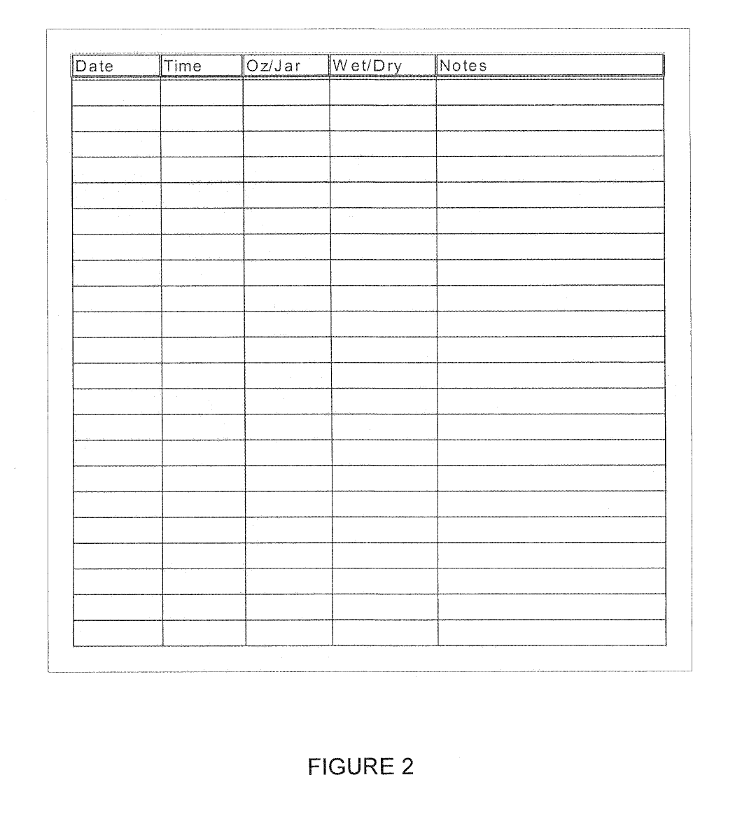

Referring now also to FIG. 2, there is shown a physical form of a page of the invention depicted in FIG. 1. As may be seen in FIG. 2, and according to an aspect of the present invention, headings may be established for columns for each page such as date, time, oz, or diaper, for example. Such a column format may provide the ability to uniquely track the number of diapers of each type occurring each day, the number of bottles and the corresponding number of ounces of formula and how often such feedings occur.

According to an aspect of the present invention, guidelines may be present for comparison to the baby's activities. Such guidelines may come from places known to those possessing an ordinary skill in the a pertinent arts, such as recommendations by the American Academy of Pediatrics, by way of non limiting example only. Other exemplary sources as described herein may also be used. For example a newborn baby may be breastfeeding 8 to 12 times a day or eating 2 to 3 ounces of formula every 3 to 4 hours or some combination thereof, having at least six wet diapers after the initial 5 to 7 days, having 3 to 4 loose yellow stools after the initial 5 to 7 days, gaining about ⅔ of an ounce a day after day after the initial 5 to 7 days and get back to his birth weight by the time the baby is 2 weeks old. While the guidelines are not hard and fast, these numbers, along with others known to those possessing an ordinary skill in the pertinent arts, may be used as guidelines for determining and measuring or comparing how a new baby is thriving.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A log directed to the organization of a baby's schedule, said log comprising:
a writeable platform for entering at least one information item;
an output entry portion of said writeable platform, said output entry related to said at least one information item and designated to correspond to various output characteristics;
an input entry portion of said writeable platform, said input entry related to said at least one information item and designated to correspond to at least one of various input characteristics; and
at least one guideline related to at least one of said input entry, said output entry and said at least one information item,
wherein the log enables feedback derived from said at least one information item and said at least one guideline.

2. The log of claim 1, wherein the log is in hard copy form.

3. The log of claim 1, wherein the log is in a soft copy form.

4. The log of claim 3, wherein said soft copy form includes a log resident on a PDA.
